(19) United States
(12) Patent Application Publication
(10) Pub. No.: US 2022/0404066 A1
(43) Pub. Date: Dec. 22, 2022

(54) PROCESS AND APPARATUS FOR COMBUSTING HYDROGEN

(71) Applicant: Kleen Hy-Dro-Gen Inc., Pickering (CA)

(72) Inventors: Sam Soliman, Pickering (CA); Roger El-Helou, Pickering (CA); Thomas Fairfull, Pickering (CA)

(21) Appl. No.: 17/774,694

(22) PCT Filed: Nov. 3, 2020
(86) PCT No.: PCT/CA2020/051490

§ 371 Date: May 5, 2022

Related U.S. Application Data
(60) Provisional application No. 62/979,206, filed on Feb. 20, 2020.
(60) Provisional application No. 62/930,866, filed on Nov. 5, 2019.

(51) Int. Cl. F24H 3/06; F24D 5/00; F24H 8/00

(52) U.S. Cl. CPC F24H 3/065; F24D 5/00; F24H 8/00

(57) ABSTRACT

There is provided a system for producing heat energy comprising: an electrolyzer for effecting electrolysis of water to produce an electrolysis product material including gaseous molecular hydrogen, and a furnace, fluidly coupled to the electrolyzer for receiving the gaseous molecular hydrogen of at least the electrolysis product material, and configured for combusting the received gaseous molecular hydrogen.

### FIELD

The present disclosure relates to heat exchanger systems for generating heat for heating fluids, such as air, by combusting gaseous molecular hydrogen.

### BACKGROUND

Existing heat exchanger systems, such as furnaces, typically rely on hydrocarbon materials as a combustible fuel for generating the desired heat energy. Hydrocarbon-based fuels are typically expensive. Also, combustion of hydrocarbon fuels generates carbon dioxide which is detrimental to the environment.

### SUMMARY

In one aspect, there is provided a system for producing heat energy comprising a source of fuel-comprising gaseous material, wherein the fuel-comprising gaseous material includes gaseous molecular hydrogen; an igniter for effecting ignition of reaction zone material within a reaction zone; and an eductor fluidly coupled to the source of the fuel-comprising gaseous material; wherein the source of fuel-comprising gaseous material, the eductor, the igniter, and the reaction zone are co-operatively configured such that, while a motive fluid is being flowed through the eductor: flow of the fuel-comprising material is induced by the flow of motive fluid, in response to the venturi effect, with effect that the induced flow of the fuel-comprising material and the motive fluid are combined such that a combined fluid material is obtained; a reaction zone supply is supplied to the reaction zone, such that the reaction zone material, within the reaction zone, is obtained, wherein the reaction zone supply includes at least the gaseous molecular hydrogen of the combined fluid material; in response to ignition of the reaction zone material within the reaction zone by the igniter, the reaction zone material is converted to reaction products via a reactive process, such that a post-reactive process gaseous material is produced, wherein the post-reactive process gaseous material includes the reaction products; the reactive process includes combustion of the gaseous molecular hydrogen; and the reactive process produces heat energy which heats the post-reactive process gaseous material such that a heated post-reactive process gaseous material is produced.

In another aspect, there is provided a system for producing heat energy comprising a source of gaseous molecular hydrogen; a manifold fluidly coupled to the source; a nozzle for discharging gaseous material feed which is received by the manifold; wherein the nozzle defines a maximum cross-sectional flow area of less than 3.14×10⁻⁶ square inches; and an igniter for effecting ignition of reaction zone material within a reaction zone; wherein: the source, the manifold, the nozzle, the igniter, and the reaction zone are co-operatively configured such that, while: (i) the gaseous material feed, including the gaseous molecular hydrogen of the source, is being received by the manifold and discharged via the nozzle to the reaction zone, and (ii) oxidant is also being supplied to the reaction zone, such that the reaction zone material, within the reaction zone, is obtained and includes the gaseous molecular hydrogen and the oxidant: in response to ignition of the reaction zone material within the reaction zone by the igniter, the reaction zone material is converted to reaction products via a reactive process, such that a post-reactive process gaseous material is produced, wherein the post-reactive process gaseous material includes the reaction products; the reactive process includes combustion of the gaseous molecular hydrogen effected by the oxidant; and the reactive process produces heat energy which heats the post-reactive process gaseous material such that a heated post-reactive process gaseous material is produced.

In another aspect, there is provided a system for producing heat energy comprising a source of gaseous molecular hydrogen; a manifold fluidly coupled to the gaseous molecular hydrogen source for receiving the gaseous molecular hydrogen; a nozzle for discharging the received gaseous molecular hydrogen; an igniter for effecting ignition of reaction zone material within a reaction zone and a flame arrestor, disposed between the manifold and the source of gaseous molecular hydrogen, for mitigating flashback from the reaction zone; wherein the source of gaseous molecular hydrogen, the manifold, the nozzle, the igniter, and the reaction zone are co-operatively configured such that, while: (i) the gaseous molecular hydrogen is being received by the manifold and discharged via the nozzle to the reaction zone, and (ii) oxidant is also being supplied to the reaction zone, such that the reaction zone material includes the gaseous molecular hydrogen and the oxidant: in response to ignition of the reaction zone material within the reaction zone by the igniter, the reaction zone material is converted to reaction products via a reactive process, such that a post-reactive process gaseous material is produced, wherein the post-reactive process gaseous material includes the reaction products; the reactive process includes combustion of the gaseous molecular hydrogen effected by the oxidant; and the reactive process produces heat energy which heats the post-reactive process gaseous material such that a heated post-reactive process gaseous material is produced.

In another aspect, there is provided a process for heating ambient air, comprising electrolyzing water, with effect that gaseous molecular hydrogen is produced; emplacing reaction zone material within a reaction zone, wherein the reaction zone material includes the produced gaseous molecular hydrogen and an oxidant; igniting the reaction zone material combined fluid material, with effect that the reaction zone material is converted to reaction products via a reactive process, such that a post-reactive process gaseous material is produced; wherein the reactive process includes combustion of the gaseous molecular hydrogen effected by the oxidant; the reaction products include water vapour; the reactive process produces heat energy which heats the post-reactive process gaseous material such that a heated post-reactive process gaseous material is produced for heating of ambient air; and the heated post-reactive process gaseous material includes the reaction products; condensing the water vapour such that liquid water is obtained; wherein the electrolyzing includes electrolyzing of the liquid water that is obtained from the condensing.

In another aspect, there is provided a process for heating ambient air, comprising: producing gaseous molecular hydrogen via electrolysis with water; combining the produced gaseous molecular hydrogen with adscititious oxidant to produce a combined fluid material; igniting the combined fluid material, with effect that the combined fluid material is converted to reaction products via a reactive process, such that a post-reactive process gaseous material is produced; wherein the post-reactive process gaseous material includes the reaction products; the reactive process includes combustion of the gaseous molecular hydrogen effected by the oxidant of the motive fluid; and the reactive process produces heat energy which heats the post-reactive process gaseous material such that a heated post-reactive process gaseous material is produced; and emplacing the heated post-reactive process gaseous material in indirect heat transfer communication with ambient air.

In another aspect, there is provided a kit of components for retrofitting a furnace that includes a conventional burner assembly and a heat exchanger, comprising an electrolyzer for effecting electrolysis of water to produce an electrolysis product material including gaseous molecular hydrogen; a gaseous hydrogen-compatible burner assembly, including a fluid conductor for receiving and conducting a reaction zone supply to a reaction zone such that a reaction zone material, within the reaction zone, is obtained, and an igniter for igniting the reaction zone material disposed within the reaction zone; wherein the electrolyzer, the gaseous hydrogen-compatible burner assembly, and the heat exchanger are co-operatively configured such that while: (i) the gaseous hydrogen-compatible burner assembly is replacing the conventional burner assembly, (ii) the gaseous hydrogen-compatible burner assembly is receiving a reaction zone supply; (iii) the electrolysis product material is being produced by the electrolyzer, and (iv) the gaseous hydrogen-compatible burner assembly is fluidly coupled to the electrolyzer, such that the received reaction zone supply includes at least the gaseous molecular hydrogen of the electrolysis product; the received reaction zone supply is conducted to the reaction zone, such that the reaction zone material includes the gaseous molecular hydrogen; in response to ignition of the reaction zone material within the reaction zone by the igniter, the reaction zone material is converted to reaction products via a reactive process that includes combustion of the gaseous molecular hydrogen, such that a post-reactive process gaseous material is produced, wherein the post-reactive process gaseous material includes the reaction products; the reactive process produces heat energy which heats the post-reactive process gaseous material such that a heated post-reactive process gaseous material is produced; and the heated post-reactive process gaseous material becomes disposed in heat transfer communication with the heat exchanger.

In another aspect, there is provided a system for producing heat energy comprising: an electrolyzer for effecting electrolysis of water to produce an electrolysis product material including gaseous molecular hydrogen, and a furnace, fluidly coupled to the electrolyzer for receiving the gaseous molecular hydrogen of at least the electrolysis product material, and configured for combusting the received gaseous molecular hydrogen.

### BRIEF DESCRIPTION OF DRAWINGS

The embodiments will now be described with reference to the following accompanying drawings, in which:

FIG. 1 is a schematic illustration of an embodiment of a heat exchanger system of the present disclosure; and

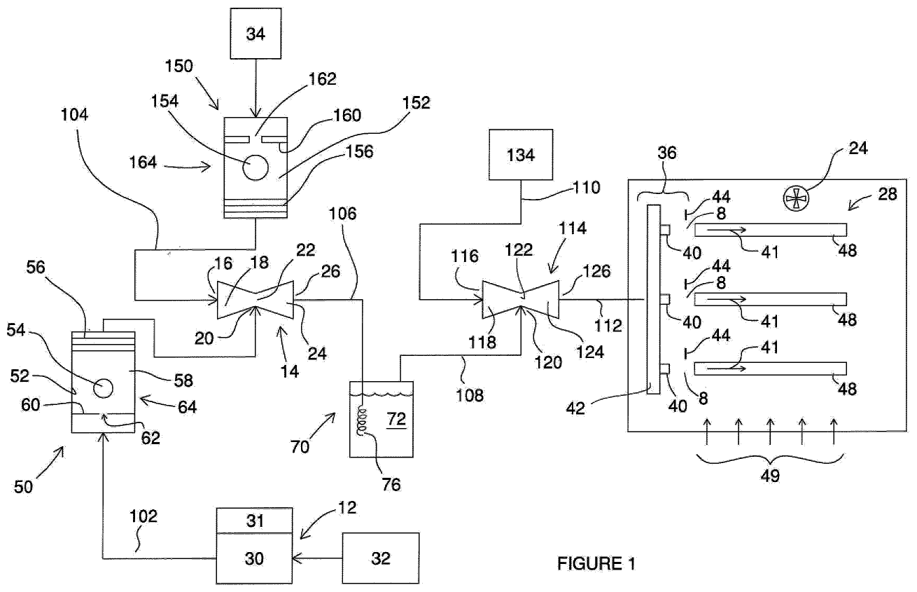

FIG. 2 is a schematic illustration of an embodiment of a conventional heat exchanger system prior to its modification to obtain the heat exchanger system illustrated in FIG. 1.

### DETAILED DESCRIPTION

There is provided a heat exchanger system 10. The heat exchanger system 10 is provided and configured to generate heat, from combustion of a gaseous fuel within a reaction zone 8, for heating ambient air for climate control of an interior space.

In some embodiments, for example, a first gaseous material supply source 12 is provided and functions to provide a source of first gaseous material 102. The first gaseous material includes a gaseous fuel. The source 12 is for supplying the first gaseous material 102 to the reaction zone 8 for combustion of the gaseous fuel. In some embodiments, for example, the gaseous fuel includes gaseous molecular hydrogen.

In some embodiments, for example, the first gaseous material 102 is combined with second gaseous material 104, such that a combined fluid material 106 is produced and supplied to the reaction zone 8. In some embodiments, for example, the second gaseous material 104 includes an oxidant, and, in this respect, within the reaction zone 8, combustion of the gaseous fuel of the first gaseous material 102 is effected by the oxidant of the second gaseous material 104. In some embodiments, for example, the second gaseous material 104 includes ambient air, such that the oxidant includes molecular oxygen. The oxidant of the second gaseous material 104 is adscititious to any oxidant that is part of the first gaseous material 102.

In some embodiments, for example, an eductor 14 (also sometimes referred to as a “venturi mixer”) is provided for inducing flow of the first gaseous material 102 with a flow of second gaseous material 104, in response to the venturi effect, with effect that at least the first gaseous material 102 and the second gaseous material 104 are combined such that a combined fluid material flow 106 is obtained, at least a fraction of which is supplied to the reaction zone 8.

In some embodiments, for example, the eductor 14 includes a motive fluid receiver 16, a converging nozzle flow passage 18, a suction fluid receiver 20, a mixing zone 22, a diverging nozzle flow passage 24, and a combined fluid material discharge communicator 26. The motive fluid receiver 16 is disposed in flow communication with the mixing zone 22 via the converging nozzle flow passage 18. The mixing zone 22 is disposed in flow communication with the combined fluid material discharge communicator 26 via the diverging nozzle flow passage 24. The suction fluid receiver 20 is disposed in flow communication with the mixing zone 22. The motive fluid receiver 16, the converging nozzle flow passage 18, the suction fluid receiver 20, the mixing zone 22, the diverging nozzle flow passage, and the combined fluid material discharge communicator 26 are co-operatively configured such that, while: (i) the motive fluid receiver 16 is receiving a flow of the second gaseous material 104 at a sufficiently high pressure, and (ii) the suction fluid receiver 20 is disposed in flow communication with the first gaseous material 102 and the first gaseous material 102 is disposed at a sufficiently low pressure:

an increase in velocity of the flow of the second gaseous material 104 is effected, as the second gaseous material flow is conducted, via the converging nozzle flow passage 18, from the motive fluid receiver 16 to the mixing zone 22, such that, concomitantly, pressure of the flow of the second gaseous material 104 decreases, with effect that the second gaseous material 104 becomes disposed within the mixing zone 22 at a reduced pressure;

flow of the first gaseous material 102 is induced, via the suction fluid receiver 20, into the mixing zone 22, in response to a pressure differential established between the mixing zone 22 and the first gaseous material 102, with effect that the flow of the second gaseous material 104 is combined (e.g. admixed) with the first gaseous material 102 to produce a flow of combined fluid material 106, the combined fluid material 106 including the first gaseous material 102 and the second gaseous material 104; and

a decrease in velocity of the flow of the combined fluid material 106 is effected, as the combined fluid material flow is conducted, via the diverging nozzle flow passage 24, from the mixing zone 22 to the combined fluid material discharge communicator 26, such that, concomitantly, pressure of the flow of the combined fluid material 106 increases, with effect that the flow of the combined fluid material 106 is discharged from the eductor 14, via the combined fluid material discharge communicator 26, at an increased pressure.

The flow of the combined fluid material 106, including the first gaseous material 102, is discharged from the eductor 14, via the combined fluid material discharge communicator 26, at a pressure that is higher than the pressure of the first gaseous material 102 upstream of the suction fluid receiver 20 of the eductor 14. In this respect, this increase in pressure of the gaseous fuel, effected by the venturi effect, enables flow of the gaseous fuel (as part of the combined fluid material flow) through a heat exchanger 28, for effecting heating of ambient air, as described below.

In some embodiments, for example, the first gaseous feed material 102 is supplied from an electrolyzer 30, such that the source 12 includes the electrolyzer 30. The electrolyzer 30 is configured for effecting electrolysis of water with effect that reaction products are obtained. In this respect, in some embodiments, for example, the electrolyzer 30 including an anode, a cathode, an electrolysis chamber containing an aqueous electrolyte solution. The anode, the cathode, and the electrolyte are co-operatively configured such that application of an electrical potential difference between the anode and the cathode effects electrolysis of water of the aqueous solution such that the reaction products, including gaseous molecular hydrogen and gaseous molecular hydrogen, are produced. The first gaseous feed material 102 is recovered from the reaction products, such that the first gaseous feed material 102 includes the produced gaseous molecular hydrogen and the gaseous molecular hydrogen of the reaction products. In this respect, in some embodiments, for example, the gaseous fuel of the first gaseous material 102 includes the produced gaseous molecular hydrogen that is recovered from the reaction product.

In some embodiments, for example, the source 12 of the first gaseous material 102 is fluidly coupled to the suction fluid receiver 20 of the eductor 14 via a first gaseous material conductor 50. In some embodiments, for example, the first gaseous material conductor 50 includes a flame arrestor 56 (for example, a composite metal foam material flame arrestor, such as a hastelloy flame arrestor) for interfering with potential flashback from the reaction zone 8. In some embodiments, for example, the first gaseous material conductor 50 includes a check valve 52 for further interfering with potential flashback from the reaction zone. In this respect, in some embodiments, for example, the check valve is a floating ball check valve 52. The floating ball check valve 52 includes a ball 54 (it is understood that the ball 54 is not necessarily spherically-shaped or otherwise ball-shaped), whose movement is constrained within a chamber 58, and a valve seat 60 configured for receiving the ball 54 for effecting closure of a flow communicator 62 (e.g. a port) that is effecting flow communication between the source 12 and the suction fluid receiver 20 of the eductor 14. In this respect, sufficient downstream pressure effects seating of the ball 54 on the valve seat 60, thereby effecting closure of the flow communicator 62, and thereby mitigating potential flashback from the reaction zone 8. In some embodiments, for example, the first gaseous material conductor 50 includes a sightglass 64 for providing visibility of the ball 54 and, thereby, amongst other things, enabling visual confirmation of flow of the first gaseous material. In some embodiments, for example, the ball 54 is a flame retardant foam ball, such as a flexible polyimide foam body. A suitable flexible polyimide foam body is made from SOLVER PI-Flexible Foam manufactured by SOLVER POLYIMIDE of Room 1401, Peninsula International Mansion, Jiande City, 311600 Zhejiang Province, China.

In some embodiments, for example, the flow of the second gaseous material 104 is supplied to the eductor 14 at a pressure of between 2 psig and 12 psig and at a velocity of at least 0.021 metres per second. In some embodiments, for example, the first gaseous material 102, which is disposed in flow communication with the suction fluid receiver 20, is disposed at a pressure of atmospheric pressure.

In some embodiments, for example, the second gaseous material 104, which is supplied to the eductor 14, is ambient air that is supplied by an air pump 34 which draws from ambient air.

In some embodiments, for example, the source 34 (for example, the air pump) of the second gaseous material 104, which is being supplied to the motive fluid receiver 16 of the eductor 14, is fluidly coupled to the motive fluid receiver 16 by a second gaseous material conductor 150. In some embodiments, for example, the second gaseous material conductor 150 includes a flame arrestor 156 (for example, a composite metal foam material flame arrestor, such as a hastelloy flame arrestor) for interfering with potential flashback from the reaction zone 8. In some embodiments, for example, the second gaseous material conductor 150 includes a check valve 152 for further interfering with potential flashback from the reaction zone. In this respect, in some embodiments, for example, the check valve is a floating ball check valve 152. The floating ball check valve 152 includes a ball 154 (it is understood that the ball 154 is not necessarily spherically-shaped or otherwise ball-shaped), whose movement is constrained within a chamber 158, and a valve seat 160 configured for receiving the ball 154 for effecting closure of a flow communicator 162 (e.g. a port) that is effecting flow communication between the source 34 and the motive fluid receiver 16 of the eductor 14. In this respect, sufficient downstream pressure effects seating of the ball 154 on the valve seat 160, thereby effecting closure of the flow communicator 162, and thereby mitigating potential flashback from the reaction zone 8. In some embodiments, for example, the second gaseous material conductor 150 includes a sightglass 164 for providing visibility of the ball 154 and, thereby, amongst other things, enabling visual confirmation of flow of the first gaseous material. In some embodiments, for example, the ball 154 is a flame retardant foam ball, such as a flexible polyimide foam body. A suitable flexible polyimide foam body is made from SOLVER PI-Flexible Foam manufactured by SOLVER POLYIMIDE of Room 1401, Peninsula International Mansion, Jiande City, 311600 Zhejiang Province, China.

In some embodiments, for example, the combined fluid material discharge communicator 26 of the eductor 14 is fluidly coupled to the burner assembly 36 via a bubbler 68. The bubbler 68 includes a combined fluid material receiver 70, for receiving a flow of combined fluid material 106 flow from the venture mixer 14, and conducting the flow of the combined fluid material 106 into a liquid medium 72 that is contained within the bubbler 68, with effect that impurities are separated from the flow of the combined fluid material 106 (such as, for example, by dissolution within the liquid medium), and such that a flow of purified combined fluid material 108 is obtained and discharged via a bubbler discharge communicator 74, of the bubbler 68, at least a fraction of which is supplied to the burner assembly 36. In some embodiments, for example, the impurities being separated include electrolyte that is carried over from the electrolyzer 30. In some embodiments, for example, the liquid medium further functions as a flame arrestor for mitigating flashback from the reaction zone 8.

In some embodiments, for example, the combined fluid material receiver 70 includes coiled tubing 76 for conducting the received combined fluid material 104. In some embodiments, for example, the coiled tubing 76 functions to effect flow resistance to any flashback from the reaction zone, thereby interfering with its propagation to the sources 12, 34 of the first and second gaseous materials, respectively. In some embodiments, for example, the coiled tubing 76 is manufactured from heat conducting material (such as copper) for facilitating heat transfer from fluid being conducted through the coiled tubing 76 to the liquid medium, and thereby further mitigating potential flashback.

In some embodiments, for example, the flow of the purified combined fluid material 108, being discharged from the bubbler 68 is accelerated in response to a venturi effect that is obtained via conduction of a third gaseous material 110 (e.g. ambient air that is supplied from an air pump 134) via a second venturi meter 114, with effect that at least the flow of the purified combined fluid material 108 and the third gaseous material flow 110 are combined such that a combined fluid material flow 112 is obtained and discharged into the reaction zone 8.

In some embodiments, for example, the second eductor 114 includes a motive fluid receiver 116, a converging nozzle flow passage 118, a suction fluid receiver 120, a mixing zone 122, a diverging nozzle flow passage 124, and a combined fluid material discharge communicator 126. The motive fluid receiver 116 is disposed in flow communication with the mixing zone 122 via the converging nozzle flow passage 118. The mixing zone 122 is disposed in flow communication with the combined fluid material discharge communicator 126 via the diverging nozzle flow passage 124. The suction fluid receiver 120 is disposed in flow communication with the mixing zone 122. The motive fluid receiver 116, the converging nozzle flow passage 118, the suction fluid receiver 120, the mixing zone 122, the diverging nozzle flow passage, and the combined fluid material discharge communicator 126 are co-operatively configured such that, while: (i) the motive fluid receiver 116 is receiving a flow of a third gaseous material 110 at a sufficiently high pressure, and (ii) the suction fluid receiver 120 is disposed in flow communication with the purified combined fluid material 108 and the purified combined fluid material 108 is disposed at a sufficiently low pressure:
an increase in velocity of the third gaseous material flow 110 is effected, as the flow of the third gaseous material 110 is conducted, via the converging nozzle flow passage 118, from the motive fluid receiver 116 to the mixing zone 122, such that, concomitantly, pressure of the flow of the third gaseous material 110 decreases, with effect that the third gaseous material 110 becomes disposed within the mixing zone 122 at a reduced pressure;
flow of the purified combined fluid material 108 is induced, via the suction fluid receiver 120, into the mixing zone 122, in response to a pressure differential established between the mixing zone 122 and the purified combined fluid material 108, with effect that the flow of the third gaseous material 110 is combined (e.g. admixed) with the flow of the combined fluid material 108 to produce a flow of combined fluid material 112; and
a decrease in velocity of the flow of the combined fluid material 112 is effected, as the flow of the combined fluid material 112 is conducted, via the diverging nozzle flow passage 124, from the mixing zone 122 to the combined fluid material discharge communicator 126, such that, concomitantly, pressure of the flow of the combined fluid material 112 increases, with effect that the flow of the combined fluid material 112 is discharged from the second eductor 114, via the combined fluid material discharge communicator 126, at an increased pressure.

The flow of the combined fluid material 112, including the gaseous fuel, is discharged from the second eductor 114, via the combined fluid material discharge communicator 126, at a pressure that is higher than the pressure of the flow of the purified combined fluid material 108 at the suction fluid receiver 120 of the second eductor 114. In this respect, this increase in pressure of the gaseous fuel, effected by the venturi effect, enables flow of the gaseous fuel (as part of the combined fluid material flow) through the heat exchanger 28, for combustion for effecting heating of ambient air.

In some embodiments, for example, the flow of the combined fluid material 112 is supplied to a burner assembly 36 for effecting the combustion of the gaseous fuel of the first gaseous material 102 within the reaction zone 8. In this respect, in some embodiments, for example, a burner assembly 36 is provided, and the burner assembly 36 includes a manifold 38 and a plurality of nozzles 40. The manifold 38 defines a manifold fluid passage network 42 for receiving the flow of the combined fluid material 112 and distributing the received combined fluid material flow amongst the plurality of nozzles 40. Each one of the nozzles 40, independently, is configured for receiving the flow of the combined fluid material 112 and discharging a portion of the flow of the combined fluid material 112 to a respective reaction zone 8, such that the combined fluid material flow, including the first gaseous material and the second gaseous material, becomes disposed within the reaction zone 8.

In some embodiments, for example, the manifold fluid passage network 42 defines a minimum cross-sectional flow area of at least 7.66×10⁻⁴ square inches. In some embodiments, for example, the manifold fluid passage network 42 defines a minimum cross-sectional flow area of between, inclusively, 7.66×10⁻⁴ square inches and 1.23×10⁻² square inches.

In some embodiments, for example, the nozzle 40 defines a maximum cross-sectional flow area of less than 3.14×10⁻⁶ square inches. In some embodiments, for example, the nozzle 40 defines a maximum cross-sectional flow area of between, inclusively, 7.85×10⁻⁷ square inches and 3.14×10⁻⁶ square inches. In some embodiments, for example, such sizing of the maximum cross-sectional flow area of the nozzle 40 mitigates potential flashback from the reaction zone 8.

The burner assembly 36 further includes, for each one of the nozzles 40, independently, an igniter 44 (such as, for example, a surface igniter), for effecting ignition of the combined fluid material 106 within the respective reaction zone 8. While the combined fluid material 106 is disposed within the respective reaction zone 8, in response to ignition by the igniter 44 (such as, for example, a surface igniter), combustion of the gaseous fuel, of the first gaseous material 102, is effected such that combustion products are produced, and with effect that a gaseous flame is obtained. Upon establishing of the gaseous flame, gaseous fuel, present within the combined fluid material 112 which is continuing to be supplied to the reaction zone 8, becomes combusted, to thereby provide continuing production of combustion products.

The combustion also generates heat energy which heats the combustion products, and any unreacted gaseous material, such that a heated post-combustion fluid material flow 41 is produced and is conducted through the heat exchanger 28, such that the heated post-combustion gaseous material becomes disposed in indirect heat transfer communication with ambient air that is drawn across the heat exchanger 28 by a circulating air fan 46, and, thus, heats the ambient air. In some embodiments, for example, the heat exchanger 28 includes a plurality of longitudinally extending tubes 48 and each one of the longitudinally extending tubes 48, independently, is aligned with a respective one of the nozzles 40. In this respect, the heated post-combustion fluid material flow 41 is conducted through the tubes 48 of the heat exchanger 28, and the ambient air, which is drawn across the heat exchanger 28 by the circulating air fan 46, is flowed as flow 49 across the outermost surface of the tubes 48, and then conducted to a predetermined space for heating the predetermined space.

In some embodiments, for example, water vapour, produced via the combustion, is condensed and collected as liquid, and the collected liquid water is conducted to a container 32 which functions as a source of water for the electrolyzer 30.

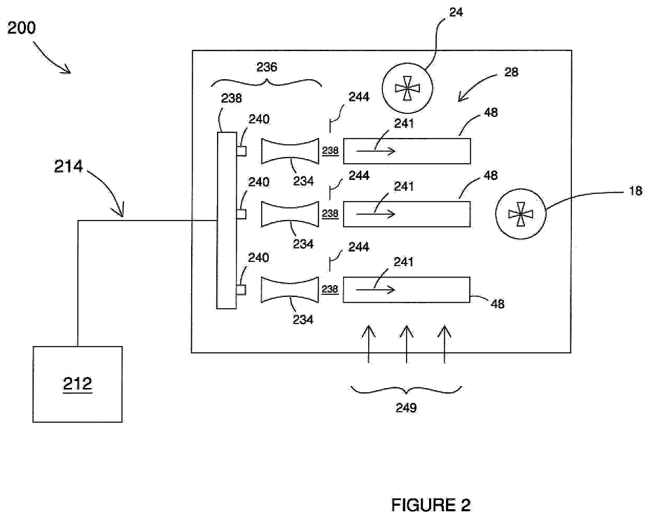

Referring to FIG. 2, typically, a conventional heat exchanger system 200 (such as a furnace) uses gaseous hydrocarbon material (such as, for example, natural gas) as the gaseous fuel. The gaseous fuel supply source 212 includes a source of pressurized gaseous fuel (such as, for example, a gaseous hydrocarbon material). The gaseous material-supplying conductor 214 supplies the gaseous fuel from the gaseous fuel supply source 212 to a burner assembly 236 for effecting combustion of the gaseous fuel within a reaction zone 238. In some embodiments, for example, the burner assembly 236 includes a manifold 238, and the manifold includes a plurality of nozzles 240. Each one of the nozzles 240, independently, is configured to discharge a portion of the gaseous fuel into the reaction zone 238 for effecting combustion of the gaseous fuel, via the burner assembly 236. The burner assembly 236 includes, for each one of the nozzles 240, independently, a respective flow mixer 234 (such as, for example, a Venturi-type burner) igniter 244 (such as, for example, a surface igniter). For each one of the igniters 244, independently, there is associated a respective reaction zone 238. The discharged gaseous fuel, and ambient air, whose flow is induced by the combustion air fan 218, are communicated from the manifold 238 to the reaction zone 238 via, and mixed within, the flow mixer 234 to generate a gaseous fuel/air mixture. While the gaseous fuel/air mixture is disposed within the reaction zone 238, in response to ignition by the igniter 244, combustion of the gaseous fuel is effected such combustion products are produced. The combustion also generates heat energy which heats the combustion products, and any unreacted gaseous material, such that a heated post-combustion gaseous material is produced. The heated post-combustion gaseous material, whose flow is being induced by the combustion air fan 218, is flowed through the heat exchanger 28, such that the heated post-combustion gaseous material becomes 46 disposed in indirect heat transfer communication with ambient air 48 that is drawn across the heat exchanger 28 by the circulating air fan 46, and, thus, heating the ambient air. In some embodiments, for example, the heat exchanger 22 includes a plurality of longitudinally extending tubes 48 and each one of the longitudinally extending tubes 48, independently, is aligned with a respective one of the nozzles 30. In this respect, the heated post-combustion gaseous material, whose flow is being induced by the combustion air fan 218, is flowed through the tubes 48 of the heat exchanger 28, and the ambient air 48, which is drawn across the heat exchanger 28 by the circulating air fan 46, is flowed across the outermost surface of the tubes 48, and then conducted to a predetermined space for heating the predetermined space.

In accordance with the present disclosure, the conventional heat exchanger system 200 is modified to enable use of gaseous molecular hydrogen as the gaseous fuel. In this respect, the conventional heat exchanger system 200 is modified to obtain the heat exchanger system 10 is provided for generating heat, via combustion of gaseous molecular hydrogen, for heating ambient air. To effect this modification, in some embodiments, for example, the burner assembly 236 of the conventional heat exchanger system is replaced by the burner assembly 36, such that gaseous fuel, in the form of gaseous molecular hydrogen, can be supplied for combustion within the modified heat exchanger system 10. In some embodiments, for example, a kit is provided for retrofitting a conventional heat exchanger system and includes the burner assembly 36 and the electrolyzer 30. In some embodiments, for example, the kit further includes the eductor 14. In some embodiments, for example, the kit includes the burner assembly 36, the eductor 14, as well as the bubbler 68 and the second eductor 114. In some embodiments, for example, the kit further includes the burner assembly 36 and the eductor 14, as well as the first gaseous material conductor 50 and the second gaseous material conductor 52, and, in some of these embodiments, further includes the bubbler 68 and the second eductor 114.

In some embodiments, for example, the electrolyzer 30 is disposed in heat transfer communication with a heat sink, such that, while the electrolysis is being effected, heat is transferred from the electrolyte to the heat sink. In some embodiments, for example, the heat sink includes a chiller 31. In this respect, in some embodiments, for example, by effecting the heat transfer, the temperature within the electrolyte is sufficiently low such that vaporization of water, of the aqueous electrolyte, is mitigated, such that the presence of water within the first gaseous material 102 is mitigated. In some embodiments, for example, the sufficiently low temperature from 27 degrees Celsius to 32 degrees Celsius. In some embodiments, for example, temperature of the electrolyte is maintained at the sufficiently low temperature by controlling the rate of heat transfer from the electrolyte to the heat sink. Water that is present within the first gaseous material 102 (and, therefore, the combined fluid material 112) may, undesirably, interrupt combustion, with effect that the gaseous flame within the furnace becomes extinguished. Once extinguished, the combustion of the gaseous fuel, continuing to be supplied to the reaction zone 8 via the combined fluid material 112, is suspended, such that the uncombusted gaseous fuel may accumulate within the furnace and potentially cause a backfire upon re-ignition of the igniter 44. Accordingly, the mitigation of the presence of water within the first gaseous material 102 (and, therefore, the combined fluid material 112), mitigates extinguishment of the gaseous flame and conditions conducive for backfiring.

In some embodiments, for example, the system further includes a sensor for sensing extinguishment of the gas flame. In some embodiments, for example, the sensor is a photocell sensor. In this respect, in some embodiments, for example, the sensor co-operates with the power supply, that is establishing the electrical potential difference between the anode and the cathode of the electrolyzer 30, such that, in response to sensing of an absence of the gaseous flame by the sensor, power being supplied to the electrolyzer 30 is suspended, with effect that the electrolysis is suspended.

In the above description, for purposes of explanation, numerous details are set forth in order to provide a thorough understanding of the present disclosure. However, it will be apparent to one skilled in the art that these specific details are not required in order to practice the present disclosure. Although certain dimensions and materials are described for implementing the disclosed example embodiments, other suitable dimensions and/or materials may be used within the scope of this disclosure. All such modifications and variations, including all suitable current and future changes in technology, are believed to be within the sphere and scope of the present disclosure. All references mentioned are hereby incorporated by reference in their entirety.

1. A system for producing heat energy comprising:
a source of fuel-comprising gaseous material, wherein the fuel-comprising gaseous material includes gaseous molecular hydrogen;
an igniter for effecting ignition of reaction zone material within a reaction zone; and
an eductor fluidly coupled to the source of the fuel-comprising gaseous material;
wherein:
the source of fuel-comprising gaseous material, the eductor, the igniter, and the reaction zone are co-operatively configured such that, while a motive fluid is being flowed through the eductor:
flow of the fuel-comprising material is induced by the flow of motive fluid, in response to the venturi effect, with effect that the induced flow of the fuel-comprising material and the motive fluid are combined such that a combined fluid material is obtained;
a reaction zone supply is supplied to the reaction zone, such that the reaction zone material, within the reaction zone, is obtained, wherein the reaction zone supply includes at least the gaseous molecular hydrogen of the combined fluid material;
in response to ignition of the reaction zone material within the reaction zone by the igniter, the reaction zone material is converted to reaction products via a reactive process, such that a post-reactive process gaseous material is produced, wherein the post-reactive process gaseous material includes the reaction products;
the reactive process includes combustion of the gaseous molecular hydrogen; and
the reactive process produces heat energy which heats the post-reactive process gaseous material such that a heated post-reactive process gaseous material is produced.

2. The system as claimed in claim 1;
wherein:
the supplying of the reaction zone supply, to the reaction zone, is effected by a nozzle; and
the nozzle includes a central axis that is aligned with the reaction zone.

3. The system as claimed in claim 2;
further comprising:
a heat exchanger;
wherein the reaction zone and the heat exchanger are co-operatively configured such that, while the heated post-reactive process gaseous material is being produced, the heated post-reactive process gaseous material becomes disposed in heat transfer communication with the heat exchanger.

4. The system as claimed in claim 3;
wherein the heat exchanger is defined by a furnace.

5. The system as claimed in any one of claims 1 to 4;
wherein:
the source of the fuel-comprising gaseous material includes an electrolyzer configured for effecting electrolysis of water with effect that gaseous molecular hydrogen is produced, such that the gaseous molecular hydrogen of the fuel-comprising gaseous material include the produced gaseous molecular hydrogen.

6. The systems as claimed in any one of claims 1 to 5;
wherein:
the motive fluid includes an oxidant; and
the reaction zone supply includes the oxidant of the motive fluid.

7. A system for producing heat energy comprising:
a source of gaseous molecular hydrogen;
a manifold fluidly coupled to the source;
a nozzle for discharging gaseous material feed which is received by the manifold;
wherein:
the nozzle defines a maximum cross-sectional flow area of less than 3.14×10⁻⁶ square inches;
and
an igniter for effecting ignition of reaction zone material within a reaction zone;
wherein:
the source, the manifold, the nozzle, the igniter, and the reaction zone are co-operatively configured such that, while: (i) the gaseous material feed, including the gaseous molecular hydrogen of the source, is being received by the manifold and discharged via the nozzle to the reaction zone, and (ii) oxidant is also being supplied to the reaction zone, such that the reaction zone material, within the reaction zone, is obtained and includes the gaseous molecular hydrogen and the oxidant:
in response to ignition of the reaction zone material within the reaction zone by the igniter, the reaction zone material is converted to reaction products via a reactive process, such that a post-reactive process gaseous material is produced, wherein the post-reactive process gaseous material includes the reaction products;
the reactive process includes combustion of the gaseous molecular hydrogen effected by the oxidant; and
the reactive process produces heat energy which heats the post-reactive process gaseous material such that a heated post-reactive process gaseous material is produced.

8. The system as claimed in claim 7;
wherein:
the source of the gaseous molecular hydrogen includes an electrolyzer configured for effecting electrolysis of water with effect that the gaseous molecular hydrogen is produced;
the gaseous molecular hydrogen, of the gaseous material feed, includes the produced gaseous molecular hydrogen.

9. The system as claimed in claim 7 or 8;
further comprising:
a heat exchanger;
wherein the reaction zone and the heat exchanger are co-operatively configured such that, while the heated post-reactive process gaseous material is being produced, the heated post-reactive process gaseous material becomes disposed in heat transfer communication with the heat exchanger.

10. The system as claimed in claim 9;
wherein the heat exchanger is defined by a furnace.

11. A system for producing heat energy comprising:
a source of gaseous molecular hydrogen;
a manifold fluidly coupled to the gaseous molecular hydrogen source for receiving the gaseous molecular hydrogen;
a nozzle for discharging the received gaseous molecular hydrogen;
an igniter for effecting ignition of reaction zone material within a reaction zone; and
a flame arrestor, disposed between the manifold and the source of gaseous molecular hydrogen, for mitigating flashback from the reaction zone;
wherein:
the source of gaseous molecular hydrogen, the manifold, the nozzle, the igniter, and the reaction zone are co-operatively configured such that, while: (i) the gaseous molecular hydrogen is being received by the manifold and discharged via the nozzle to the reaction zone, and (ii) oxidant is also being supplied to the reaction zone, such that the reaction zone material includes the gaseous molecular hydrogen and the oxidant:
in response to ignition of the reaction zone material within the reaction zone by the igniter, the reaction zone material is converted to reaction products via a reactive process, such that a post-reactive process gaseous material is produced, wherein the post-reactive process gaseous material includes the reaction products;
the reactive process includes combustion of the gaseous molecular hydrogen effected by the oxidant; and
the reactive process produces heat energy which heats the post-reactive process gaseous material such that a heated post-reactive process gaseous material is produced.

12. The system as claimed in claim 11;
wherein:
the flame arrestor includes a bubbler; and
the manifold is fluidly coupled to the source of gaseous molecular hydrogen via the bubbler.

13. The system as claimed in claim 11;
wherein:
the manifold is fluidly coupled to the source of gaseous molecular hydrogen via a check valve;
the check valve includes a valve body configured for seating on a valve seat for effecting closure of flow communication between the manifold and the source of gaseous molecular hydrogen;
the valve body comprises flame retardant material; and
the flame arrestor is defined by the valve body.

14. The system as claimed in any one of claims 11 to 13;
further comprising:
a heat exchanger;
wherein the reaction zone and the heat exchanger are co-operatively configured such that, while the heated post-reactive process gaseous material is being produced, the heated post-reactive process gaseous material becomes disposed in heat transfer communication with the heat exchanger.

15. The system as claimed in claim 14;
wherein the heat exchanger is defined by a furnace.

16. A process for heating ambient air, comprising:
electrolyzing water, with effect that gaseous molecular hydrogen is produced;
emplacing reaction zone material within a reaction zone, wherein the reaction zone material includes the produced gaseous molecular hydrogen and an oxidant;
igniting the reaction zone material combined fluid material, with effect that the reaction zone material is converted to reaction products via a reactive process, such that a post-reactive process gaseous material is produced;
wherein:
the reactive process includes combustion of the gaseous molecular hydrogen effected by the oxidant;
the reaction products include water vapour;
the reactive process produces heat energy which heats the post-reactive process gaseous material such that a heated post-reactive process gaseous material is produced for heating of ambient air; and
the heated post-reactive process gaseous material includes the reaction products;
condensing the water vapour such that liquid water is obtained;
wherein the electrolyzing includes electrolyzing of the liquid water that is obtained from the condensing.

17. The process as claimed in claim 16;
further comprising:
emplacing the heated post-reactive process gaseous material in indirect heat transfer communication with ambient air, such that the ambient air is heated with heated post-reactive process gaseous material and the condensing of the water vapour is effected.

18. The process as claimed in claim 16 or 17;
wherein:
the electrolyzing of the water is with additional effect that oxygen is produced; and
the oxidant includes the produced oxygen.

19. A process for heating ambient air, comprising:
producing gaseous molecular hydrogen via electrolysis with water;
combining the produced gaseous molecular hydrogen with adscititious oxidant to produce a combined fluid material;
igniting the combined fluid material, with effect that the combined fluid material is converted to reaction products via a reactive process, such that a post-reactive process gaseous material is produced;
wherein:
the post-reactive process gaseous material includes the reaction products;
the reactive process includes combustion of the gaseous molecular hydrogen effected by the oxidant of the motive fluid; and
the reactive process produces heat energy which heats the post-reactive process gaseous material such that a heated post-reactive process gaseous material is produced;
and
emplacing the heated post-reactive process gaseous material in indirect heat transfer communication with ambient air.

20. The process as claimed in claim 19;
wherein:
the combining of the produced gaseous molecular hydrogen with adscititious oxidant includes inducing flow of the produced gaseous molecular hydrogen with a motive fluid, in response to the venturi effect, with effect that the induced flow of the produced gaseous molecular hydrogen and the motive fluid are combined such that the combined fluid material is produced; and
the motive fluid includes the adscititious oxidant.

21. A kit of components for retrofitting a furnace that includes a conventional burner assembly and a heat exchanger, comprising:
an electrolyzer for effecting electrolysis of water to produce an electrolysis product material including gaseous molecular hydrogen;
a gaseous hydrogen-compatible burner assembly, including a fluid conductor for receiving and conducting a reaction zone supply to a reaction zone such that a reaction zone material, within the reaction zone, is obtained, and an igniter for igniting the reaction zone material disposed within the reaction zone;
wherein:
the electrolyzer, the gaseous hydrogen-compatible burner assembly, and the heat exchanger are co-operatively configured such that while: (i) the gaseous hydrogen-compatible burner assembly is replacing the conventional burner assembly, (ii) the gaseous hydrogen-compatible burner assembly is receiving a reaction zone supply; (iii) the electrolysis product material is being produced by the electrolyzer, and (iv) the gaseous hydrogen-compatible burner assembly is fluidly coupled to the electrolyzer, such that the received reaction zone supply includes at least the gaseous molecular hydrogen of the electrolysis product;
the received reaction zone supply is conducted to the reaction zone, such that the reaction zone material includes the gaseous molecular hydrogen;
in response to ignition of the reaction zone material within the reaction zone by the igniter, the reaction zone material is converted to reaction products via a reactive process that includes combustion of the gaseous molecular hydrogen, such that a post-reactive process gaseous material is produced, wherein the post-reactive process gaseous material includes the reaction products;
the reactive process produces heat energy which heats the post-reactive process gaseous material such that a heated post-reactive process gaseous material is produced; and
the heated post-reactive process gaseous material becomes disposed in heat transfer communication with the heat exchanger.

22. The kit as claimed in claim 21;
wherein:
the gaseous hydrogen-compatible burner assembly includes a nozzle for effecting the discharging of the received reaction zone supply to the reaction zone; and
the nozzle defines a maximum cross-sectional flow area of less than 3.14×10⁻⁶ square inches.

23. The kit as claimed in claim 21 or 22;
further comprising:
an eductor;
wherein:
the electrolyzer, the gaseous hydrogen-compatible burner assembly, and the eductor are co-operatively configured such that while: (i) the gaseous hydrogen-compatible burner assembly is replacing the conventional burner assembly; (ii) the gaseous hydrogen-compatible burner assembly is receiving a reaction zone supply; (iii) the electrolysis product material is being produced by the electrolyzer; (iv) the eductor is fluidly coupled to the electrolyzer for receiving at least the gaseous molecular hydrogen of the electrolysis product; (v) a motive fluid is being flowed through the eductor such that flow of at least the gaseous molecular hydrogen, of the electrolysis product, is induced by the flow of motive fluid, in response to the venturi effect, with effect that the motive fluid and the induced flow of at least the gaseous molecular hydrogen are combined such that a combined fluid material is obtained and includes the gaseous molecular hydrogen of the electrolysis product; and (vi) the gaseous hydrogen-compatible burner assembly is fluidly coupled to the eductor such that the received reaction zone supply includes at least the gaseous molecular hydrogen of the combined fluid material:
the gaseous molecular hydrogen, of the electrolysis product of the received reaction zone supply, includes the gaseous molecular hydrogen of the combined fluid material.

24. The kit as claimed in any one of claims 21 to 23;
further comprising:
a heat sink;
wherein the electrolyzer is configured for emplacement in heat transfer communication with the heat sink, such that while electrolysis is being effected by the electrolyzer such that heat is being produced by the electrolysis, at least a portion of the generated heat is transferred to the heat sink.

25. The kit as claimed in claim 24;
wherein the heat sink includes a chiller.

26. A system for producing heat energy comprising:
an electrolyzer for effecting electrolysis of water to produce an electrolysis product material including gaseous molecular hydrogen; and
a furnace, fluidly coupled to the electrolyzer for receiving the gaseous molecular hydrogen of at least the electrolysis product material, and configured for combusting the received gaseous molecular hydrogen.

27. The system as claimed in claim 26;
further comprising:
a heat sink;
wherein the electrolyzer is disposed in heat transfer communication with the heat sink, such that while electrolysis is being effected by the electrolyzer such that heat is being produced by the electrolysis, at least a portion of the generated heat is transferred to the heat sink.

28. The system as claimed in claim 27;
wherein the heat sink includes a chiller.
